(19) United States
(12) Patent Application Publication
(10) Pub. No.: US 2006/0146519 A1
(43) Pub. Date: Jul. 6, 2006

(54) Shining device for a manual electric tool

(76) Inventor: Jung-Chia Yu, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/024,675

(22) Filed: Dec. 30, 2004

(51) Int. Cl. B25B 23/18

(52) U.S. Cl. 362/119

(57) ABSTRACT

A shining device for a manual electric tool includes a light source fixed on a manual electric tool, a control circuit connected electrically to the light source, a control switch connected to the control circuit for turning on and off the light source, an electric double layer capacitor connected to a battery of the electric tool. The light device can be used in a dark place and moved together with the electric tool so as to avoid the undesired conditions of some working areas or corners lack of light. The light source can also be lit to flash on and off, shown as a warning signal. In addition, the electric double layer capacitor can supply the light source with weak electricity by storing the electric volume of basic potential difference of the battery even if the electricity of the battery is used up.

### BACKGROUND OF THE INVENTION

1. Field of the Invention

This invention relates to a shining device for a manual electric tool, particularly fixed on an outer end of a manual electric tool such as an electric drill, an electric screw-driver, etc. enables a user to use the electric tool in a comparatively dark place, and additionally give out a warning by flashing on and off the light. Further, an electric double layer capacitor (E.D.L.C.) added in the shining device can supply the light source with weak electricity for a little while even if the electricity of a battery is used up.

2. Description of the Prior Art

Nowadays various manual electric tools are widely used for works such as drilling, cutting, tapping, and so on, offering convenience and pragmatism for daily life of common people.

However, in practicability thereof, if they are used in comparatively dark places, users must prepare other separate lights for making their workplaces brightened, and which can cause the undesired condition of some working areas or corners lack of light; on the other hand, it is inconvenient for users to move the separate lights to provide sufficient light with the working areas or corners from time to time as well as a quite harassment.

### SUMMARY OF THE INVENTION

A shining device for a manual electric tool in the invention includes a light source fixed on an outer end of the electric tool and a control electric circuit connected with the light source and a control switch connected between the control circuit and the light source to turn on and out the light source. Further, an electric double layer capacity is connected to a battery of an electric tool. Therefore, under a dark or dim condition of a workplace, the control switch can be handled to turn on the light source so that a user can carry on the work with the electric tool, As the light source can move together with the electric tool, there arises no problem of a dead angle for shining, with the light source also possible to be lit to flash on and off in order to indicate an warning, Besides, the electric double layer capacitor can store a small volume of electricity for supplying some power for the light source to keep on shining for a little while even if all the electricity of the battery are used up.

### BRIEF DESCRIPTION OF A DRAWING

This invention will be better understood by referring to the accompanying drawing, wherein:

FIG. 1 is a block figure of an electric circuit in a shining device for an electric tool in the present invention.

### DETAILED DESCRIPTION OF THE PREFERRED EMBODIMENT

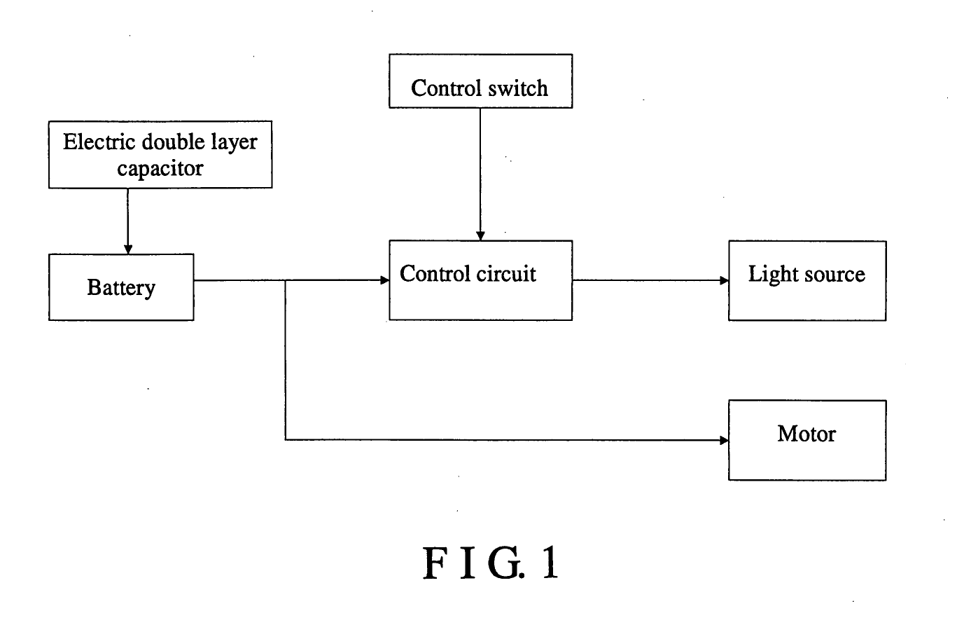

A preferred embodiment of a shining device for an electric tool in the present invention, as shown in FIG. 1, includes a light source 2, a control circuit 21 provided in a manual electric tool 1 and electrically connected to the light source 2, a battery 11 placed in the electric tool 1, and an electric double layer capacitor 12 placed in the electric tool 1 and connected to the battery 11. And a motor 13 getting electricity from the battery 11 and a control switch 22 connected to the control circuit 21 and fixed on an outer surface of the manual electric tool 1.

In using, if a user holds the electric tool 1 to work in a dim or dark place, the user handles the control switch 22 to turn on the light source 2 via the control circuit 21 to give out light to shine a workplace and the outer end or tip of the electric tool 1. As the light source 2 is fixed on the outer end of the manual electric tool 1, it can be moved together with the electric tool 2 so as to avoid some working areas or corners with little light. In addition, the light source 2 can also be controlled to be lit to flash on and off as a warning signal for other people.

Next, the battery 11 may have its electric volume falling down to a lowest point, and the electric double layer capacitor 12 can store feeble electric volume of the basic potential difference of the battery 11 and supply the light source 2 with the weak electricity for lighting the light source for a little while even if the battery 12 is used up.

In short, the shining device for a manual electric tool is positioned at the outer end of the electric tool can supply light during the processes of working with the electric tool in a dark place, and continuously make the light source work for a while even if the battery is completely used up. Accordingly, it shows more convenience and practicability for people in use.

While the preferred embodiment of the invention has been described above, it will be recognized and understood that various modifications may be made therein and the appended claims are intended to cover all such modifications that may fall within the spirit and scope of the invention.

What is claimed is:

1. A shining device for a manual electric tool comprising a light source affixed on an outer end of a manual electric tool, a control circuit provided in said electric tool and connected electrically with said light source, a control switch fixed on an outer surface of said electric tool and connected electrically with said control circuit, said control circuit connected with a battery of said electric tool, an electric double layer capacitor connected with said battery, said battery supplying a motor with electricity:
Said light source possible to be lit up for shining a work which said electric tool is used for in case a user uses said electric tool in a dark place, said light source still possible to be lit up for a little while by said electric double layer capacitor even if said battery is used up.

2. The shining device for a manual electric tool as claimed in claim 1, wherein said light source is able to be lit to flash on and off by said control circuit as a warning signal.
